(19) United States
(12) Patent Application Publication
(10) Pub. No.: US 2023/0332906 A1
(43) Pub. Date: Oct. 19, 2023

(54) SYSTEM AND METHOD FOR LOADING A VEHICLE TRAILER

(71) Applicant: Steering LLC, Sunny Isles Beach, FL (US)

(72) Inventor: Dmitrii Shchelkanov, Sunny Isles Beach, FL (US)

(21) Appl. No.: 18/027,399

(22) PCT Filed: Sep. 23, 2021
(86) PCT No.: PCT/US21/50429

§ 371 Date: Mar. 21, 2023

Related U.S. Application Data
(60) Provisional application No. 63/080,975, filed on Sep. 21, 2020.

(51) Int. Cl. G01C 21/34; G06Q 10/083

(52) U.S. Cl. CPC G01C 21/3461; G01C 21/343; G06Q 10/083

(57) ABSTRACT

A system for configuring a load of vehicles on a trailer for transport includes a network connected interface for receiving vehicle information, driver information, and trailer information. A database coupled to the network interface is configured to store regulations governing trailer use, driver information, vehicle information and trailer information. A regulation compliance engine coupled to the database is configured to receive the trailer information, the regulations governing trailer use, the vehicle information and determining as a function thereof whether at least one regulation is violated. A route determination engine communicating with the database is configured to receive the driver information and vehicles information, the vehicle information including a pickup location and drop off location for each vehicle, and determining a travel route for the trailer as a function thereof.

### CROSS REFERENCE TO RELATED APPLICATION

This application claims the benefit of U.S. Provisional Application No. 63/080,975 filed on Sep. 21, 2020, the entire disclosure of which is hereby incorporated in its entirety.

### BACKGROUND

The present invention is directed to a system and method for loading a vehicle trailer, and more particularly, for arranging the load to optimize the distribution of the vehicles on the trailer and/or completion of a delivery route.

Vehicles such as automobiles have been shipped by trailer almost since the beginning of the automotive age. However, the arrangement of the vehicles on the trailer and selection of the route itself have been haphazard at best; a driver arranging to pick up and transport vehicles in a happenstance manor, often at the dictates of a broker or dispatcher who would arrange hauls for the driver as booked.

Vehicles would be arranged on the trailer in an order dictated by the manner in which the broker or dispatcher assigned vehicles to particular drivers; when and where.

This luck of the draw booking resulted in haphazard loads which often violated road safety rules and regulations. More importantly it often left drivers with empty backhauls (Deadhead) for the return trip; costing the driver time and money; as well as in this green age, spending fossil fuels for no benefit.

Accordingly, it is desired to utilize a system in accordance with a method that overcomes the shortcomings of the prior art.

### SUMMARY OF THE INVENTION

A system for configuring a load of vehicles on a trailer for transport includes a network connected interface for receiving vehicle information, driver information, and road train (tractor and trailer) characteristic information. A database coupled to the network interface is configured to store load distribution characteristics, driver information, vehicle information and road train information. A route determination engine communicating with the database is configured to receive the driver information and vehicle information, the vehicle information including a pickup location and drop off location for each vehicle, and determining a travel route for the trailer as a function of the driver information and vehicle information.

In another embodiment a regulation compliance engine is coupled to the database, the database stores regulations governing road train use, and is configured to receive the road train information, the regulations governing trailer use, the load distribution characteristics, the vehicle information and determining as a function of the road train information, the regulations governing trailer use, and the vehicle information whether at least one regulation is violated by the configuration of a proposed vehicle load.

In another embodiment, a load determination engine determines as a function of the regulations governing trailer use and the vehicle information whether the distribution of a load within the trailer is in violation of any regulation. The load determination engine providing a visual indicator of the occurrence of a violation of at least one regulation.

In yet another embodiment, an unload determination engine communicating with the database is configured to receive the trailer information, route information and a configuration of a load from the load determination engine and determining whether the vehicles as currently loaded on the trailer are in proper order for unloading. The unload determination engine indicting to the driver, which vehicles are in an improper location on the trailer.

A method for configuring a load of vehicles for transport on a trailer of a road train, the method including the steps of receiving at a network connected interface vehicle information, driver information, and trailer information. Regulations governing trailer use, load distribution characteristics, driver information, vehicle information and trailer information are stored at a database. It is then determined, as a function of stored trailer information, the regulations governing trailer use, and the vehicle information, whether at least one regulation is violated.

The method may further include the step of determining a travel route for the trailer as a function of the driver information and vehicle information; the vehicle information including a pickup location and drop off location for each vehicle.

In yet another embodiment of the invention an order for unloading the each of the vehicles is determined as a function of the position of each vehicle on the trailer and the timing of each drop off location of the route.

In yet another embodiment of the invention the vehicle is an autonomous vehicle, and the driver information corresponds to operation of a vehicle autonomously.

### BRIEF DESCRIPTION OF THE DRAWINGS

The present disclosure will be better understood by reading the written description with reference to the accompanying drawing figures in which like reference numerals denote similar structure and refer to like elements throughout in which:

FIG. 1 a schematic diagram of the system in accordance with the invention;

FIG. 2 is a flowchart of the method performed by the system in accordance with the invention:

FIG. 3 is a schematic diagram of the method for determining the route by the system in accordance with the invention;

FIGS. 4a, 4b are each a schematic representation of the load as calculated by the system and as utilized as a graphical warning indicator o a driver in accordance with the invention; and

FIG. 5 is a schematic diagram depicting elements and data flow of determination of a vehicle load configuration in accordance with the invention.

While various embodiments are amenable to various modifications and alternative forms, specifics thereof have been shown by way of example in the drawings and will be described in detail. It should be understood, however that the intention is not to limit the claimed inventions to the particular embodiments described. On the contrary, the intention is to cover all modifications, equivalents and alternatives falling within the spirit and scope of the subject matter as defined by the claims.

### DETAILED DESCRIPTION

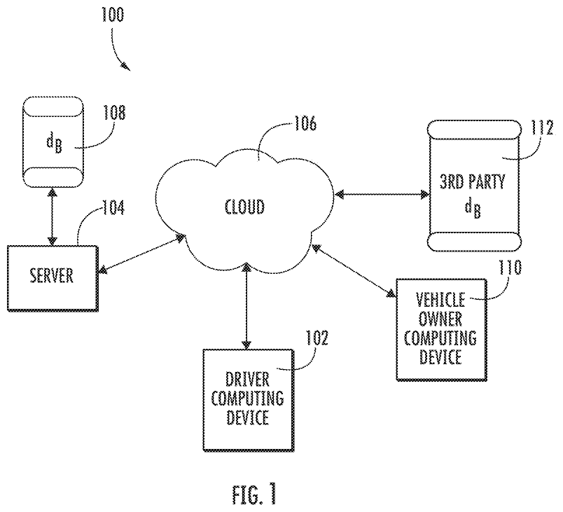

Reference is first made to FIG. 1 in which a system, generally indicated as 100, constructed in accordance with the invention is provided. System 100 includes a driver computing device 102 through which a driver communicates, through cloud 106, with a server 104 and database 108.

System 100 may be initialized by a driver utilizing driver computing device 102. Information such as the driver's first and last name, their United States Department of Transportation (“USDOT”) license, their EIN (to enable issuance of reports such as a W-9), insurance details and even bank information for direct deposit payment. Additionally, the driver would enter information about their tractor and trailers, i.e. make model of the trailer and tractor (together a “road train”). They may also be required to enter the Vehicle Identification Number (“VIN”) for their tractor as well as the license plate number. The above information may be uploaded by a driver at driver computing device 102 to be stored by server 104 in database 108. However, server 104 may, in a preferred non limiting embodiment, communicate with a third party database 112 to obtain necessary information to initialize system 100 for a driver.

When operating in an autonomous mode the vehicle would not require the driver's first and last name, their United States Department of Transportation (“USDOT”) license, their EIN (to enable issuance of reports such as a W-9), insurance details and even bank information, but would include other vehicle specific operation parameters corresponding to autonomous operation of the tractor and train load.

Additionally, the driver may have route and driving preferences to limit distance from a home base, or even the states through which they wish to limit their routes, or even just desire to avoid tolls. As a driver inputs these geographical preferences at driver computing device 102, server 104 creates a geofence for any potential route developed for each driver as a function of these inputs.

A third party data base 112 is illustrated as a single database, but is representative of a number of databases both private and public for use by system 100. So that, by way of non limiting example, by utilizing the VIN of a driver's tractor, as input by the driver, server 104 utilizes the VIN to confirm/obtain the tractor make and model from a data source such as the issuing government agency. With the confirmed tractor make and model, server 104 obtains the load capacity, height, weight, number of axles and turning radius information with respect to the tractor, trailer and/or road train combination and maps such information to the driver and their tractor/trailer combination for various road trains, which is stored at database 108 for use by server 104, in constructing loads as will be discussed below. This information is stored by server 104 in database 108 as part of a driver profile.

Third party database 112 may also include information regarding road conditions as obtained from traffic condition websites. Third party database 112 may also include information regarding roadway and infrastructure load maximums, heights, widths and speed limits and other regulations, trailer weight limitations, and such laws and rules as stored at a database such as those operated by USDOT, or the state equivalents.

A vehicle owner computing device 110 also communicates with server 104, through cloud 106 in a preferred nonlimiting embodiment. A vehicle owner enters an order for vehicle transportation at computing device 110 by entering the make and model of the vehicle to be transported, the pick-up location and the drop off location. As an accuracy check, in a nonlimiting preferred embodiment, the vehicle owner may enter the VIN for the proposed vehicle, enabling server 104 to confirm the vehicle characteristics. This information is transmitted to server 104 and stored in database 108. It is understood that computing devices 102. and 110 can be any device capable of having information input thereto and transmitted to server 104 such as a personal computer, laptop, tablet, and preferably a cell phone or the like by way of non-limiting example.

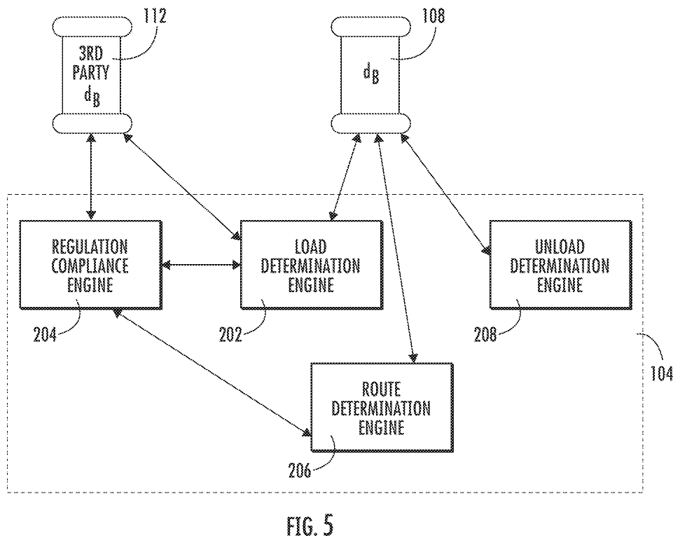

Reference is now made to FIG. 5 wherein the operational structure of server 104, in accordance with the invention, is provided. A load determination engine 202 communicates with third party database 112, database 108 and a regulation compliance engine 204. Load determination engine 202 is configured to receive information about each tractor/trailer combination as a load for such combination is being constructed from database 108. Load determination engine 202 is also configured to receive information about each vehicle, as it is loaded onto an identified trailer of a road train, from database 108, or from third party database 112 as a function of information from database 108. For example, if a VIN for a vehicle to be loaded is received by load determination engine 202, then the VIN can be used to access third party database 112 to either obtain or confirm, make model and vehicle weight and height for a loaded vehicle.

A route determination engine 206 is configured to communicate with database 108 and as a function of each delivery point and drop off point for a particular vehicle, as entered by each vehicle owner, and a driver determined geofence, determines a route for the driver. The route is stored in database 108 and is pushed to the driver in a real time basis. As will be seen below the route can be changed as a function of vehicles added to the load.

A regulation compliance engine 204 is configured to communicate with third party database 112 and load determination engine 202, and determine, as a load for each load train is built by server 104, whether the load is in compliance with regulations and rules governing operation of the tractor and trailer. For example, certain loads are banned from certain roadways or infrastructures as a function of weight or height, or even turning radius. If a violation of the requirements, rule or regulation for a particular road train is determined by regulation compliance engine 204, it will send an indication to the driver, at driver computing device 102, that the load needs to be reconfigured.

Regulation compliance engine 204, or alternatively route determination engine 206, working with regulation compliance engine 204, may also utilize a store of minimum requirements as stored in either third party database 112 or database 108 to determine the suitability of an identified route and respective load for a road train. For example, if a route as determined by route determination engine 206 has sharp turns, load determination engine 202 is configured to act with regulation compliance engine 204 to determine whether the load as constructed, including the tractor/trailer, can navigate the route determined by route determination engine 206; i.e. the load exceeds weight allowances, or the turning roadway diameter is too small to be navigated by the selected tractor and/or trailer.

There are also regulations by way of example for load weight per trailer axle. Load determination engine 202 is also configured to receive the identity of each vehicle and determine whether placement on the trailer, at a particular position, will cause violation of the maximum permitted load per axle, by way of example. Again, if a violation of the requirements, rule or regulation is determined by regulation compliance engine 204, it will send an indication to the driver, at driver computing device 102, that the load needs to be reconfigured.

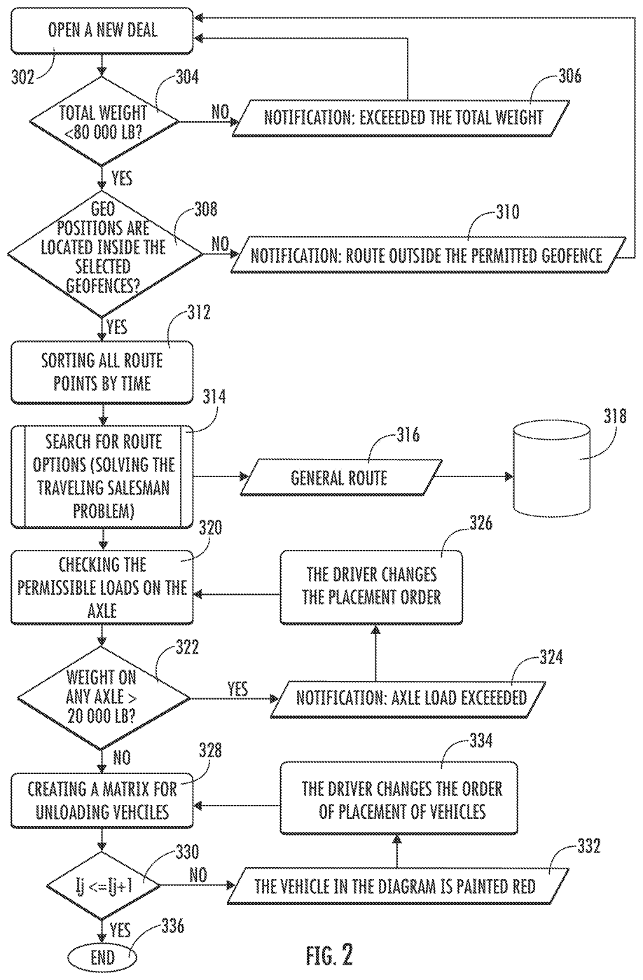

Reference is now made to FIG. 2 in which a flowchart illustrating operation of system 100 in accordance with the invention is provided. Vehicle owners are continuously inputting requests for transport as a function of vehicle make, model and preferably VIN, drop off location and pick up location through vehicle owner computing device 110. Prior thereto the driver has initialized their presence on the system by inputting the information discussed above utilizing driver computing device 102.

In a step 302 a driver seeking to transport vehicles, using driver computing device 102, connects with server 104. Server 104 selects a potential vehicle for transport by the driver, as submitted by the vehicle owner in a step 302. In a step 304 regulation compliance engine 204, operating with load determination engine 202 determines -whether the addition of the vehicle to a driver load causes violation of any regulation, in this example, the law against the entire weight of the tractor, trailer and vehicle loaded thereon exceeding 80,000 pounds (the “limit”). Load determination engine 202 determines the weight of the vehicle being added either from information obtained from database 108, or using information stored in database 108 to access third party database 112. Regulation compliance engine 204 then calculates the weight of the entire load, including the newly input vehicle, and determines whether the total weight exceeds 80,000 pounds in the present example.

If this is the first vehicle to be added, and the total weight of the load as determined in step 304 is less than the lit it, the process passes to step 308. However, if the load is determined to exceed the limit in step 304, then in a step 306 regulation compliance engine 204 will send an alert to driver computing device 102, that the rule has been violated and the process will return to step 302 with another vehicle and customer's vehicle will be passed to another driver/truck.

A vehicle owner enters the pick up location(A) and drop off location (B) into database 108. Additionally, a preferred pick up time (Ta) and drop off time (Tb) is entered with each vehicle by the owner. It is then determined by route determination engine 206, in a step 308, whether all of the load pick up locations and drop off locations are within the geofence as stored in database 108. If, any location is determined to be outside of the geofence, route determination engine 206 causes a notification to be sent to the driver at driver computing device 102 that the vehicle cannot be accepted for transport in a step 310. The process then returns to step 302 for processing of a new vehicle. Of course, it is well within the scope of the invention for the driver to expand their geofence in real time to accommodate such vehicles in response to the notification. This step may also occur automatically, processing another vehicle, without notifying the driver which vehicle has been rejected.

If in step 308 it is determined that the entire route is within the geofence, then a route is designed for the driver. In a step 312, route determination engine 206, having a desired pick up time and drop off time for each vehicle, sorts all vehicle processing (transactions) by time of loading (pick up) and unloading (drop off) to determine a route.

Reference is now made to FIG. 3 in which a diagram of a route calculated in accordance with the invention is provided. As discussed above all pick ups and drop offs may be identified as DN {A, B, Ta, Tb} where N is an integer, A is a pick up location for a particular vehicle N, B is the drop off location for the vehicle, Ta is the pickup time and Tb is the drop off time. As discussed above, route determinations engine 206 initially sorts the sequence of transactions by time. As a result, a route is developed as shown in FIG. 3.

In FIG. 3 N=5, as there are five vehicles (transactions/deals). The integers of DN may represent the: order in which the vehicle was booked. So that A₁ is the pickup location of the first vehicle booked and B₅ is the drop off location of the last vehicle booked. In a step 314 the various transactions are broken up into pick up locations and drop off locations as a function of time. When sorted by time by route determination engine 206, as shown in FIG. 3, rather than location, or order of transaction, pick up of the first booked vehicle (N=1) at its pickup location A₁ does not occur first. Rather, pick up of the second booked vehicle, location A₂, is processed first and then the second stop is pick up of the fifth booked vehicle A₅, and so on until location ten which is the drop off location of the fourth booked vehicle, B₄. Pick up of the first booked vehicle at location A₁ does not occur until the sixth stop along the route.

Route determination engine 206, using timing as a base may then modify the route as a function of a desire for no toll roads, trailer turning radius, or the like. The route may also be calculated as a function of minimizing route length in miles, travel time in predicated hours or the like. These factors are input at driver computing device 102 to be processed by route determination engine 206; the route being determined as a general route, step 316, is provided to the driver and stored in database 108 for further reference or operation thereon. The driver selects one of the route options in step 316, which is stored in database 318. In a preferred embodiment, each route is provided as a GUI interface on driver computing device 102, and selection of the desired route is then stored in database 108.

As can be seen in this example three vehicles are picked up before a first is dropped off at stop 4, B₂. It should also be understood that in route, as vehicles are dropped off, a driver may pick up additional vehicles, not previously booked. Route determination engine 206 reconfigures the route as a function of time to calculate the new route. Additionally, at least steps 302, 304, 308, and 312 are also repeated for a vehicle added by the driver while in route.

Most basically the vehicles are loaded in order of pick up. However, there are regulations regarding the distribution of weight on the trailer. A most commonly encountered regulation is that, there are permissible load limits on each axle of the of the tractor and trailer; currently 9.07 tons per axle; about 20,000 pounds. Position of the vehicles on the trailer directly affects the load above each axle. Load determination engine 202, acting in cooperation with regulation compliance engine calculates the load over the axle and determines whether it exceeds the statutory limits.

In a step 320 load determination engine 202 may determine the weight of the load over each axle. In a step 312, load determination engine 202 determines, working with regulation compliance engine 204, whether the weight over any one axle exceeds a legal limit; 20,000 pounds. Axle loads are calculated as the sum of the weights of all weights in the slots (positions on the trailer assigned to a respective vehicle) to the ratios of the moments from the center of the filled (vehicle carrying) slot to the center of mass of the axle plus an axle load of the tractor itself and the trailer If the threshold is exceeded then a notification is sent to the driver at driver computing device 102.

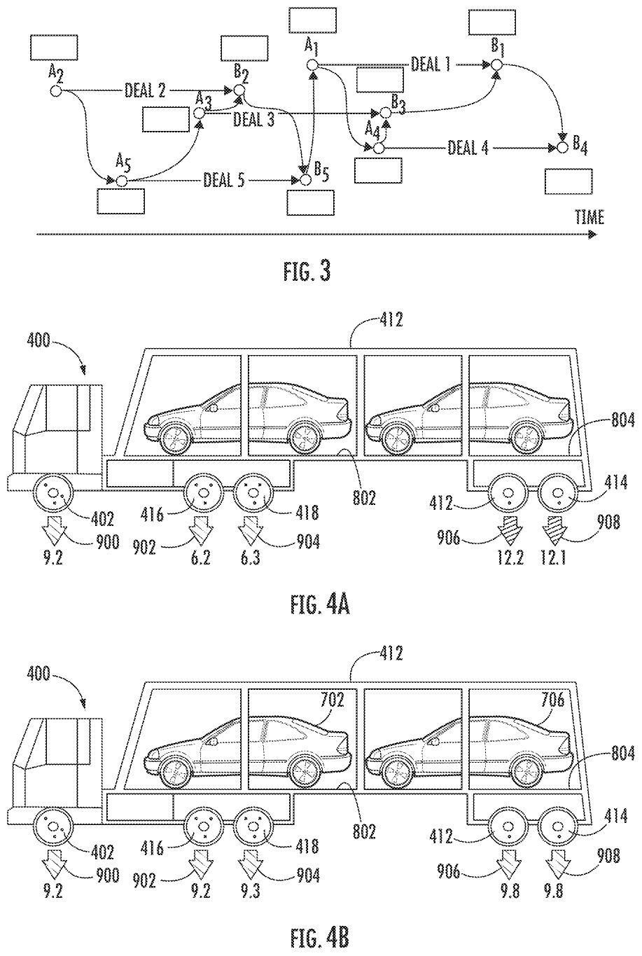

Reference is now made to FIGS. 4a, 4b in which the indication to the driver of the axle condition in accordance with he invention is shown. Load determination engine includes a loading editor which graphically shows the load on each axle at driver computing device 102. A tractor 400 having axles 402, 416 and 418 is shown by way of example. A trailer 412, having slots 802, 804 has at least two axles 412, 414. Vehicles 700, 702 are disposed in slots 802, 804 respectively and vehicle 702 is significantly heavier than vehicle 700.

As discussed above in one non limiting embodiment load determination engine calculates the load on each axle. As shown in FIG. 4a, a graphical representation of the load at each axle is provided by arrows 900-908 respectively and an associated numerical indication of the load experienced at each axle. Arrow 900 indicates that axle 402 experiences 9.2 tons of weight, while arrows 902 and 904 indicate loads of 6.2. tons and 6.3 tons respectively; all within allowable parameters. However, arrows 906, and 908 indicate values for axles 412. and 414 in excess of allowed limits. This indicates to the driver that the load needs to be redistributed. As a further indicator, compliant values can be shown in green and violation values may be shown in a different color such as red at driver computing device 102. The vehicle of interest, in this case vehicle 702, may also be indicated in red.

As seen in FIG. 4b a redistribution of the load, switching the order of the vehicle load, as calculated by load determination engine 202, places the loads within acceptable limits. As a result, each of arrows 900-908 are exhibiting green as is each vehicle 700, 702. This provides a quick reference for the driver to determine whether the loads are properly balanced.

As can be determined from the above, route determination engine 206, working with load determination engine 202, and in turn, in one embodiment, regulation compliance engine 204, not only determines an optimal route as a function of either one of timing or distance, but may also use at least one of the physical characteristics of the road train as a function of the tractor/trailer specifications stored in either database, the height of the tractor/trailer and vehicles loaded thereon, the length of the tractor/trailer, the turning radius of the tractor trailer, and the axle load.

Once the trailer is configured and the route has been determined system 104 performs a check to determine whether the loaded vehicles are in proper order for unloading. It should be noted that unless a driver can perform first on last off (“FILO”) or last on first off (“LIFO”) loading and unloading, each pickup and drop off location may require reconfiguration of the load to optimize the drop off order.

Unload determination engine 208, communicates with database 108 and determines the location, as expressed by slot location, of each vehicle on the trailer. Unload determination engine 208 then determines whether the vehicles are in the appropriate slots for optimal unloading as function of slot location within the trailer and drop off time; drop off sequencing. Unload determination engine 208 is configured to receive the slot information and vehicle load sequence from database 108 and determine the location of each vehicle in the trailer as a function of slot location. As is readily understood this functionality, in one embodiment may be combined with the functionality of load determination engine 202.

In a step 330 unload determination engine 208 creates a matrix of drop off locations B, such that the abscissa is the order of unloading(I) and the ordinate is the slot number of the vehicle in the trader (j). In a step 330, Ij is then solved so that if Iⱼ≤Iⱼ+1, then the vehicle for the next unloading along the route is in the correct slot. However, if Iⱼ≥Iⱼ+1, then the vehicle represented by Iⱼ+1 is in the wrong slot, the unloading order is not correct.

The solution for optimizing the matrix is to have a value of 1 along the diagonal of the matrix, and the null set for each remaining value. The vehicle of interest can only be in one slot at a time, and in an optimized matrix the slot should correspond to the diagonal of the matrix for each respective vehicle's unloading order and slot number (a particular vehicle in a particular slot).

In a preferred nonlimiting embodiment unload determination engine 208 sends an indication which vehicle is in the wrong slot as guidance for the driver to move the incorrectly, positioned vehicle to optimize the matrix. A schematic of the load, such as that in FIG. 4a may show the vehicle needing movement in a different color than the others, such as red in a step 332 and the driver changes the order of vehicles in a step 334 and the process is returned to step 330, until the value in step 330 is a correct indication of Iⱼ≤Iⱼ+1. Once true for all trailer locations the process ends in step 336.

It should be noted that as system 100 determines that a vehicle has been offloaded, and an empty slot exists on trailer 412, system 100 returns to step 302 to offer a new vehicle for consideration first by system 100 then by the driver. It should also be noted that while the above embodiment was described in connection with vehicles, it is adaptable to any route and load with shifting inventory, such as a moving company, a truck for warehouse inventory redistribution, or the like.

A System in accordance of the invention autonomously configures a load to optimize efficiency in pick and drop off along the route as a function of time, distance, or other driver preferences such as toll road avoidance. The basic route is then also reconfigured on behalf of the driver to comply with load regulations such as overall weight, and weight at a particular axle. Additionally, as each car is dropped off, the system is enabled to offer another car for pick up fitting the load criteria including preexisting puck up and drop off times, and load balancing.

As a result of utilizing a system for loading vehicles on a trailer in accordance with the invention the system is enabled to autonomously add vehicles for pick up which comply with the necessary rules, regulations and preferences of the driver. As a result of such autonomous operation, the invention lends itself not only to driverless operation, but to a hub and spoke system where transportation hubs are provided, and local tow trucks will deliver vehicles to such hubs and then driverless trucks will transport the vehicles over the long haul distances between hubs for local towing to the final destination.

While specific embodiments have been described in detail in the foregoing detailed description and illustrated in the accompanying drawings, those with ordinary skill in the art will appreciate that various modifications and alternatives to those details could be developed in light of the overall teaching of the disclosure. For example the invention easily encompasses semi tractors and semi-trailers, which are generically also tractors and trailers. Accordingly, the particular arrangements disclosed are meant to be illustrative only and not limiting as to the scope of the invention, which is to be given the full breadth of the appended claims in any and all equivalents thereof.

What is claimed is:

1. A system for configuring a load of vehicles on a trailer for transport, the trailer being coupled to a tractor to form a road train, the system comprises:
a network connected interface for receiving vehicle information; driver information, and road train characteristic information;
a database coupled to the network interface is configured to store load distribution characteristics, driver information, and vehicle information ; the driver information including at least one of driver's first and last name, their United States Department of Transportation license, driver EIN, insurance details, bank information and autonomous operation information; the vehicle information includes at least one of make and model of the vehicle, Vehicle identification Number, and license plate number;
a route determination engine communicating with the database configured to receive the driver information and vehicle information, the vehicle information further including a pickup location and drop off location for each vehicle, determines a travel route for the road train as a function of the driver information and vehicle information and determines the load configuration within the trailer as a function of the travel route, the driver information, and vehicle information.

2. The system for configuring a load of vehicles on a trailer for transport of claim 1, wherein the database stores regulations governing road train use; and the system further comprising a regulation compliance engine coupled to the database; the regulation compliance engine being configured to receive the road train information, the regulations governing trailer use, the load distribution characteristics, the vehicle information and determine as a function of the road train information, the regulations governing trailer use, and the vehicle information whether at least one regulation is violated; and the route determination engine further determining the route as a function of the regulations governing road train use.

3. The system for configuring a load of vehicles on a trailer for transport of claim 2, further comprising, a load determination engine configured to determine, as a function of the regulations governing trailer use and the vehicle information, whether the distribution of a load within the trailer is in violation of any regulation.

4. The system for configuring a load of vehicles on a trailer for transport of claim 1, further comprising an unload determination engine communicating with the database and being configured to receive the trailer information, route information and a configuration of a load as determined by the load determination engine and determining whether the vehicles as currently loaded on the trailer are in proper order for unloading.

5. A method for configuring a load of vehicles for transport on a trailer of a road train, comprising the steps of:
receiving at a network connected interface, vehicle, information, driver information, and trailer information; the driver information including at least one of driver's first and last name, their United. States Department of Transportation license, driver EIN, insurance details, bank information and autonomous operation information; the vehicle information includes at least one of make and model of the vehicle, Vehicle identification Number, and license plate number;
storing driver information, vehicle information and trailer information in a database; and
determining, as a function of stored trailer information, and the vehicle information, a route for delivering each vehicle in a load of vehicles and positioning of each vehicle relative to the trailer as a function of the stored driver information, trailer information, vehicle information and determined route; and configuring the load of vehicles as a function of the route, driver information and vehicle information.

6. The method of claim 5, further comprising the step of storing regulations governing trailer use in the database; and further determining the route for delivering each vehicle in the load of vehicles and positioning of each vehicle relative to the trailer as a function of the regulations governing trailer use.

7. The method of claim 5, further comprising the step of determining a travel route for the trailer as a function of the driver information and vehicle information; the vehicle information including a pickup location and drop off location for each vehicle.

8. The method of claim 5, further comprising the step of determining an order for unloading the each of the vehicles as a function of the position of each vehicle on the trailer and a timing of each drop off location of the route.
